(19) United States
(12) Patent Application Publication
(10) Pub. No.: US 2008/0318558 A1
(43) Pub. Date: Dec. 25, 2008

(54) SYSTEM AND METHOD FOR THE SIGNALING OF SESSION CHARACTERISTICS IN A COMMUNICATION SESSION

(75) Inventors: Imed Bouazizi, Tampere (FI); Ramakrishna Vedantham, Sunnyvale, CA (US)

Correspondence Address: FOLEY & LARDNER LLP, P.O. BOX 80278, SAN DIEGO, CA, 92138-0278, US

(73) Assignee: Nokia Corporation

(21) Appl. No.: 12/141,011

(22) Filed: Jun. 17, 2008

Related U.S. Application Data
(60) Provisional application No. 60/945,049, filed on Jun. 19, 2007.

(51) Int. Cl. H04M 3/42

(52) U.S. Cl. 455/414.1

(57) ABSTRACT

A system and method for specifying requirements for the consumption of an MBMS user service. This system and method is forward-compatible and allows for legacy terminals to detect if a new feature, introduced in later releases, is required for the consumption of the service. If a required feature is not supported, then the terminal will not attempt to join the session. The service announcement or service discovery carries information about the requirements for the MBMS user service. Any requirement that is not understood by the terminal indicates to the terminal that it cannot correctly receive and decode the service.

### CROSS-REFERENCE TO RELATED APPLICATIONS

The present application claims priority to U.S. Provisional Patent Application No. 60/945,049, filed Jun. 19, 2007, incorporated herein by reference.

### FIELD OF THE INVENTION

The present invention relates generally to the use of the Multimedia Broadcast/Multicast Service (MBMS). More particularly, the present invention relates to the signaling of session characteristics during a MBMS communication session.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

In recent years, mobile broadcast solutions have been standardized by different organizations, such as the 3rd Generation Partnership Project (3GPP) MBMS service. MBMS is a broadcasting service that can be offered via existing Global System for Mobile Communications (GSM) and Universal Mobile Telecommunication System (UMTS) cellular networks. 3GPP MBMS provides the ability to multicast or broadcast data to 3GPP terminals in a cost efficient manner.

FIG. 1 is a depiction of the MBMS system architecture 100. In the system architecture 100, the broadcast multicast service center (BM-SC) 110, located within an IP network 115, is responsible for several actions, including service announcements, service registration, security functions, data delivery, billing and charging. As such, the BM-SC 110 is an enabler of MBMS services. The BM-SC 110 receives content from a content provider 120 and provides the content through a core network 125, namely through a gateway general packet radio service (GPRS) support node (GGSN) 130 and a serving GPRS support node (SSGN) 135. The SSGN 135 in turn provides the content to one or more MBMS receivers 140 via networks such as a GSM Enhanced Data for GSM Evolution (EDGE) radio access networks (GERAN) 145 or a UMTS terrestrial radio access network (UTRAN) 150.

MBMS content can be delivered to a receiver using one or more delivery methods. Delivery methods include a download method and a streaming method. Different applications may use different delivery methods when delivering content to MBMS subscribers, depending on the requirements of each application. For example, a mobile TV would use the streaming delivery method, while messaging applications (e.g., Multimedia Messaging Service (MMS) applications), as well as music and video clip downloading, would use the file download method.

The MBMS streaming service defines a set of media codecs and formats that are to be used by MBMS services. Currently, the following video codecs are specified in MBMS. However, other video codecs are also possible, and the codecs below may also be modified.

H.263 Profile 0 Level 45

In Release 6: H.264 Baseline Profile Level 1b is recommended

In Release 7: H.264 Baseline Profile Level 1.2 is recommended

A pair of audio codecs are also currently recommended—Enhanced AAC+ and AMR-WB+. Once again, other audio codecs are also possible, and the above audio codecs may also be modified.

MBMS user services are typically announced before the start of an MBMS session or during the session itself. This process is performed using the MBMS User Service Discovery/Announcement function. The service announcement procedure comprises sending the User Service Description (USD) either via multicast (using an MBMS file download session) or via unicast, e.g. using Open Mobile Alliance (OMA) PUSH mechanisms. The USD is a collection of metadata fragments that are related together, describe the user service, and provide the necessary information to access the service. MBMS defines a number of metadata fragments. The Associated Delivery Procedure Description fragment describes additional procedures such as file repair or reception reporting. The Session Description fragment carries the Session Description Protocol (SDP) of the session, which is used to tune in and configure the session. The Security Description fragment describes the service protection procedure that is used to protect the MBMS user service. The FEC Repair Stream Description fragment describes the forward error correction (FEC) stream that protects the service bundle.

The metadata fragments of the USD and their relationships are depicted in FIG. 2. As shown in FIG. 2, the User Service Description fragment 200 includes a User Service Bundle Description fragment (USBD) 210, which itself references the FEC Repair Stream Description fragment 220. A Delivery Method fragment 230 references the Associated Delivery Procedure description fragment 240, the Session Description fragment 250, and the Security Description Fragment 260. The Delivery Method fragment 230 also includes the User Service Description Fragment 200.

The USD may describe multiple services that are bundled together using the USBD fragment 210. A USBD fragment 210 may contain one or more USD instances. A USBD fragment 210 may refer to a single FEC Repair Stream Description fragment 220. A USD fragment 210 describes the details of a single MBMS user service identified by its service id. The USD contains other descriptive items including the name(s) and language(s) of the MBMS user service. The various metadata fragments are placed into an MBMS Metadata Envelope, which embeds the fragments in a format that is suitable for transport. The MBMS Metadata envelope may carry any type of data fragment (i.e., not only MBMS metadata fragments).

In MBMS Release 7 (Rel-7), MBMS was extended to enable the reception of mid-quality video (i.e., CIF@15 Hz) by changing the requirement for the H.264 level from 1b to 1.2b. This enables the existence of a mixture of MBMS user services (i.e., some user services that are addressed to Rel-7 terminals only, and some user services are decodable by both Release 6 (Rel-6) and Rel-7 terminals). Furthermore, it is expected that additional updates and extensions to the MBMS user service requirements (e.g., audio/video codecs, security protection, etc.) will be standardized in the future.

Digital Video Broadcasting (DVB) IP Datacast (IPDC) and OMA Broadcast (BCAST) define a service guide that carries a description of a service at issue. The IPDC Electronic Service Guide defines, in the Acquisition Fragment, the semantics of component characteristics. The receiving terminal can detect the characteristics of the service and decide whether it can consume the service or not. However, the future compatibility of this arrangement is not assured, as new requirements cannot be easily added and understood by legacy terminals in this system.

The Session Description fragment of the MBMS USD also carries codec-related information for any media streams being transported in the MBMS session. However, the media clients are normally designed in such a way as to ignore any SDP parameters that they do not understand. Therefore, a Rel-6 MBMS terminal that receives an SDP containing a Rel-7 codec parameter may simply ignore that parameter, and the terminal will receive the content that it its media decoder cannot parse.

### SUMMARY OF THE INVENTION

Various embodiments provide a system and method for signalling requirements for the consumption of an MBMS user service. This system and method is forward-compatible, allowing receiving terminals to detect whether new feature(s), if introduced, for example within the service description, is/are required for the consumption of the service. If a required feature is not supported, then the terminal will not attempt to join the session. The service announcement or service discovery according to various embodiments carries information about the requirements for the MBMS user service. Any requirement that is not understood by the terminal, or recognized as requiring (e.g., software and/or hardware) features that are not supported by the terminal, indicates to the terminal that it cannot correctly consume the service, e.g., it cannot correctly receive or decompress the data associated with the service, or the terminal does not have the required software or hardware to run applications associated with the service. Various embodiments can be implemented in different types of devices, network elements, networks and systems, and the various embodiments may be used in conjunction with a wide variety of standards and use situations.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a MBMS system architecture;

FIG. 2 shows the interrelationships among MBMS User Service Description Metadata fragments;

FIG. 3 is a flow chart showing the implementation of various embodiments of the present invention;

FIG. 4 is a perspective view of an electronic device that can be used in conjunction with the implementation of various embodiments; and

FIG. 5 is a schematic representation of the circuitry which may be included in the electronic device of FIG. 4.

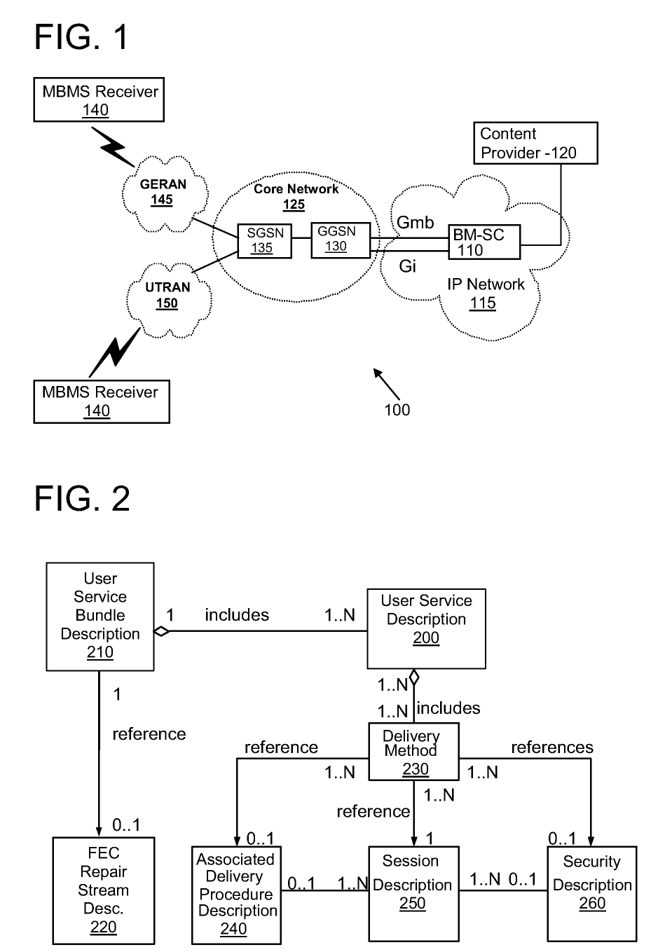

### DETAILED DESCRIPTION OF VARIOUS EMBODIMENTS

Various embodiments provide a system and method for signalling requirements for the consumption of an MBMS user service. This system and method is forward-compatible, allowing receiving terminals to detect whether new feature(s), if introduced, for example within the service description, is/are required for the consumption of the service. If a required feature is not supported, then the terminal will not attempt to join the session. The service announcement or service discovery according to various embodiments carries information about the requirements for the MBMS user service. Any requirement that is not understood by the terminal, or recognized as requiring (e.g., software and/or hardware) features that are not supported by the terminal, indicates to the terminal that it cannot correctly consume the service, e.g., it cannot correctly receive or decompress the data associated with the service, or the terminal does not have the required software or hardware to run applications associated with the service. Various embodiments can be implemented in different types of devices, network elements, networks and systems.

A set of feature values is defined to identify the different features that may be used by MBMS user services. According to various embodiments, the user service announcement is modified to include a list of required features. One particular embodiment makes use of the MBMS User Service Description to include the list of requirements. Example syntax for the modified USD is as follows:

<xs:complexType name=“userServiceDescriptionType”>

<xs:sequence>

<xs:element name=“RequireFeature” type=“RequireFeatureType” minOccurs=“1”

maxOccurs=“unbounded”/>

<xs:element name=“name” type=“nameType” minOccurs=“0” maxOccurs=“unbounded”/>
<xs:element name=“serviceLanguage” type=xs:language” minOccurs=“0”

maxOccurs=“unbounded”/>

<xs:element name=“deliveryMethod” type=“deliveryMethodType”

maxOccurs=“unbounded”/>

<xs:element name=“accessGroup” type=“accessGroupType” minOccurs=“0”

maxOccurs=“unbounded”/>

<xs:any namespace=“**other” minOccurs=“0” maxOccurs=“unbounded”

processContents=“lax”/>

</xs:sequence>
<xs:attribute name=“serviceId” type=“xs:anyURI” use=“required”/>
<xs:anyAttribute processContents=“ski”W/>

</xs:complexType>
<xs:complexType name=“RequireFeatureType”>

<xs:attribute name=“feature” value=“xs:string” use=“required”/>
<xs:attribute name=“minValue” value=“xs:string” use=“optional”/>
<xs:attribute name=“maxValue” value=“xs:string“ use=optional”/>
<xs:attribute name=“Value” value=“xs.string use=“optional”/>

</xs complexType>

A list of features can also be defined for different versions or releases of MBMS. For example, Rel-7 defines the following features:

VideoCodec: “H.264” and “H.263” are possible

VideoCodecProfile: “Baseline”, “0”, “3”

VideoCodecLevel: “1b”, “1.2”, “45” are defined

AudioCodec: “Enhanced AMR-WB” and “Enhanced aacPlus”

In addition to the above, other features may be defined for security, transport protocols, FEC protection, etc. For example, the following is an example of a User Service Description fragment including the feature indication:

<?xml version=“1.0” encoding=“UTF-8”?>
<bundleDescription

xmlns=“urn:3GPP:metadata:2005:MBMS:userServiceDescription”
xmlns:xsi=“http://www.w3.org/2001/XMLSchema-instance”
fecDescriptionURI=http://www.example.com/3gpp/mbms/session1-fec.sdp”>
<userServiceDescription serviceId=“urn:3gpp:1234567890coolcat”>

<requireFeature feature=“VideoCodec” Value=“H.264”/>
<requireFeature feature=“VideoCodecLevel” Value=“1.2”/>
<name lang=“EN”>Welcome</name>
<name lang=“DE”>Willkommen</name>
<name lang=“FR”>Bienvenue</name>
<name lang=“FI”>Tervetuloa</name>
<serviceLanguage>EN</serviceLanguage>
<serviceLanguage>DE</serviceLanguage>
<deliveryMethod accessGroupId=“1”

sessionDescriptionURI=“http://www.example.com/3gpp/mbms/session1.sdp”>

<deliveryMethod

sessionDescriptionURI=http://www.examp1e.com/3gpp/mbms/session2.sdp”

associatedProcedureDescriptionURI=“http://www.example.com/3gpp/mbms/procedureX.xml

“/>

<deliveryMethod

sessionDescriptionURI=“http://www.example.com/3gpp/mbms/session3.sdp”

associatedProcedureDescriptionURI=“http://www.example.com/3gpp/mbms/procedureY.xml

“/>

<deliveryMethod accessGroupId=“2”

sessionDescriptionURI=http://www.example.com/3gpp/mbms/session4.sdp”>

<accessGroup id=“1”>

<accessBearer>3GPP.R6.GERAN</accessBearer>
<accessBearer>3GPP.R6.UTRAN</accessBearer>

</accessGroup>
<accessGroup id=“2”>

<accessBearer>3GPP.R6.UtRAN</accessBearer>

</accessGroup>

</userServiceDescription>

</bundleDescription>

Upon encountering one or more features, the terminal does not join a relevant MBMS session if it cannot understand one or more of the features it encounters relating to the session, or if it encounters any feature values that it does not support. In one embodiment, this is accomplished by having the specification text that is sent to the receiving terminal indicate that the terminal should not join the session if one or more of the required features are not supported or understood. In another embodiment, XML syntax parsing can be set to “strict,” and feature names can be defined as controlled terms.

FIG. 3 is a flow showing a process by which various embodiments may be implemented. At 300 in FIG. 3, the BM-SC generates a service announcement for at least one MBMS session, including an indication that a receiving terminal should not join a particular MBMS session if it cannot understand or support a feature (e.g., a software feature, hardware feature, a video codec, an audio codec, etc.) in the service announcement. At 310, the service announcement is broadcast or multicast to one or more receiving terminals. The service announcement may also be sent via Short Messaging Service (SMS) bearers or HTTP bearers using the OMA PUSH OTA specifications. At 320, a particular receiving terminal receives the service announcement. If the receiving terminal does not understand or support a feature in the service announcement, then at 330 it decides not to join the session. If, on the other hand, the receiving terminal understands and supports all of the features, then it joins the related MBMS session at 340.

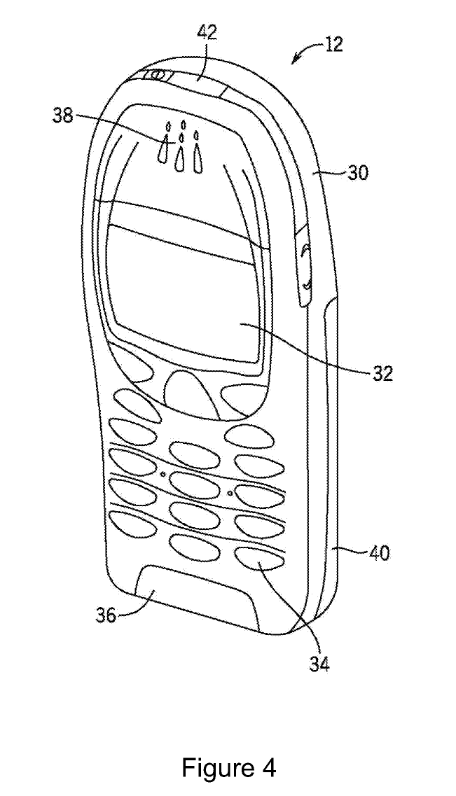

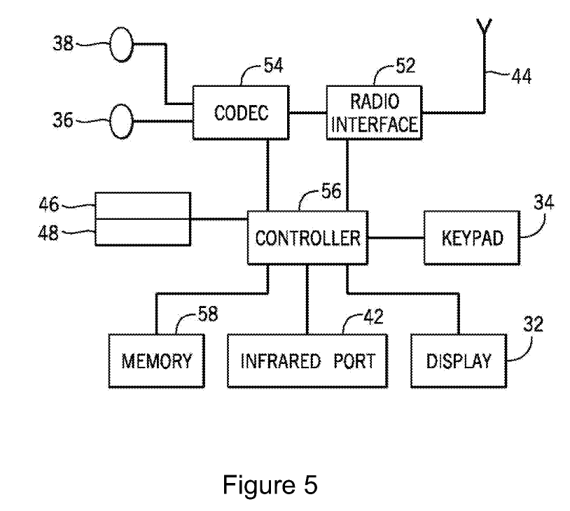

FIGS. 4 and 5 show one representative electronic device 12 within which various embodiments of the present invention may be implemented. Each of the various devices described in the present application may contain one or more of the elements depicted in the electronic device 12 of FIGS. 4 and 5. It should be understood, however, that the present invention is not intended to be limited to one particular type of electronic device 12. The electronic device 12 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80.

The present invention is described in the general context of method steps, which may be implemented in one embodiment by a program product including computer-executable instructions, such as program code, executed by computers in networked environments. Various embodiments of the present invention may be implemented in network elements and/or servers of a service provider. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. Additionally, it should also be noted that the applicability of the various embodiments of the present invention is not limited to any particular standard or Release, or to any version of a particular standard or Release. The embodiments were chosen and described in order to explain the principles of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, network elements, and computer program products.

What is claimed is:

1. A method, comprising:
receiving, at a receiving terminal, a service announcement, the service announcement comprising one or more feature requirements associated with a service;
if the receiving terminal cannot understand or support any of the one or more feature requirements, deciding not to join the service; and
if the receiving terminal can understand or support the one or more feature requirements, subscribing to the service.

2. The method of claim 1, wherein the one or more feature requirements are included in a multimedia broadcast multicast service (MBMS) user service description (USD).

3. The method of claim 1, further comprising reading an indication that the service should not be joined if the receiving terminal cannot understand or support any of the one or more feature requirements.

4. The method of claim 3, wherein the indication is included in the MBMS USD.

5. The method of claim 3, wherein the indication comprises an XML syntax parsing that is set to “strict,” and wherein names for the one or more feature requirements are set as controlled terms.

6. The method of claim 1, wherein at least one of the one or more feature requirements is one of a software feature, a hardware feature, an audio codec and a video codec.

7. A computer program product, embodied in a computer-readable storage medium, comprising computer code configured to:
receive, at a receiving terminal, a service announcement, the service announcement comprising one or more feature requirements associated with a service;
if the receiving terminal cannot understand or support any of the one or more feature requirements, decide not to join the service; and
if the receiving terminal can understand or support the one or more feature requirements, subscribe to the service.

8. An apparatus, comprising:
an electronic device configured to:
receive, at a receiving terminal, a service announcement, the service announcement comprising one or more feature requirements associated with a service;
if the receiving terminal cannot understand or support any of the one or more feature requirements, decide not to join the service; and
if the receiving terminal can understand or support the one or more feature requirements, subscribe to the service.

9. The apparatus of claim 8, wherein the one or more feature requirements are included in a multimedia broadcast multicast service (MBMS) user service description (USD).

10. The apparatus of claim 8, wherein the electronic device is further configured to read an indication that the service should not be joined if the receiving terminal cannot understand or support any of the one or more feature requirements

11. The apparatus of claim 10, wherein the indication is included in the MBMS USD.

12. The apparatus of claim 10, wherein the indication comprises an XML syntax parsing that is set to “strict,” and wherein names for the one or more feature requirements are set as controlled terms.

13. The apparatus of claim 8, wherein at least one of the one or more feature requirements is one of a software feature, a hardware feature, an audio codec and a video codec.

14. An apparatus, comprising:
means for receiving, at a receiving terminal, a service announcement, the service announcement comprising one or more feature associated with a service;
means for, if the receiving terminal cannot understand or support any of the one or more feature requirements, deciding not to join the service; and
means for, if the receiving terminal can understand or support the one or more feature requirements, subscribing to the service.

15. A method, comprising:
preparing a service announcement comprising one or more feature requirements associated with a service; and
sending the service announcement to at least one receiving device.

16. The method of claim 15, wherein the one or more feature requirements are included in a multimedia broadcast multicast service (MBMS) user service description (USD).

17. The method of claim 15, further comprising preparing an indication that the service should not be joined by a receiving terminal if the receiving terminal cannot understand or support any of the one or more feature requirements.

18. The method of claim 17, wherein the indication is included in the MBMS USD.

19. The method of claim 17, wherein the indication comprises an XML syntax parsing that is set to “strict,” and wherein names for the one or more feature requirements are set as controlled terms.

20. The method of claim 15, wherein at least one of the one or more feature requirements is one of a software feature, a hardware feature, an audio codec and a video codec.

21. A computer program product, embodied in a computer-readable storage medium, comprising computer code configured to:
prepare a service announcement comprising one or more feature requirements associated with a service; and
send the service announcement to at least one receiving device.

22. An apparatus, comprising:
an electronic device configured to:
prepare a service announcement comprising one or more feature requirements associated with a service; and
send the service announcement to at least one receiving device.

23. The apparatus of claim 22, wherein the one or more feature requirements are included in a multimedia broadcast multicast service (MBMS) user service description (USD).

24. The apparatus of claim 22, wherein the electronic device is further configured to prepare an indication that the service should not be joined by a receiving terminal if the receiving terminal cannot understand or support any of the one or more feature requirements.

25. The apparatus of claim 24, wherein the indication is included in the MBMS USD.

26. The apparatus of claim 24, wherein the indication comprises an XML syntax parsing that is set to “strict,” and wherein names for the one or more feature requirements are set as controlled terms.

27. The apparatus of claim 22, wherein at least one of the one or more feature requirements is one of a software feature, a hardware feature, an audio codec and a codec video codec.

28. An apparatus, comprising:
means for preparing a service announcement comprising one or more feature requirements associated with a service; and
means for sending the service announcement to at least one receiving device.

29. A system, comprising:
a broadcast multicast service center (BM-SC) configured to:
prepare a service announcement comprising one or more feature requirements associated with a service; and
at least one receiving terminal configured to:
receive the service announcement when transmitted from the BM-SC;
if the receiving terminal cannot understand or support any of the one or more feature requirements, decide not to join the service; and
if the receiving terminal can understand or support the one or more feature requirements, join the service.

30. A network element, comprising:
a processor; and
a memory unit communicatively connected to the processor and comprising:
computer code for processing a service announcement comprising one or more feature requirements associated with a service.

31. The network element of claim 30, wherein the one or more feature requirements are included in a multimedia broadcast multicast service (MBMS) user service description (USD).

32. The network element of claim 30, wherein the memory unit further comprises computer code for processing an indication that the service should not be joined by a receiving terminal if the receiving terminal cannot understand or support any of the one or more feature requirements

33. The network element of claim 32, wherein the indication is included in the MBMS USD.

34. The network element of claim 32, wherein the indication comprises an XML syntax parsing that is set to “strict,” and wherein names for the one or more feature requirements are set as controlled terms.
